(19) United States
(12) Patent Application Publication
(10) Pub. No.: US 2008/0016406 A1
(43) Pub. Date: Jan. 17, 2008

(54) TESTING SYSTEM FOR PORTABLE ELECTRONIC DEVICES AND METHOD OF USING THE SAME

(75) Inventors: CHAO-HUNG WEI, Shindian (TW); HONG SHAN, Shindian (TW); TIE-SHAN JIA, Shenzhen (CN); HUI NIU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/619,473

(22) Filed: Jan. 3, 2007

(30) Foreign Application Priority Data
Jul. 14, 2006 (CN) 200610061645.1

(51) Int. Cl. G06F 11/00

(52) U.S. Cl. 714/44

(57) ABSTRACT

A testing system (100) for testing quality of portable electronic devices includes a processor (10) and a plurality of testing apparatuses (20) connected to the processor. The processor includes a database module (13); the database module saves testing programs and testing parameters. The testing apparatuses are configured for receiving testing data from the portable electronic devices and sending the testing data to the processor. The processor processes the testing data to test quality of the portable electronic devices and check working status of each testing apparatus at the same time of testing quality of the portable electronic devices.

### BACKGROUND OF THE INVENTION

1. Field of the Invention

The present invention generally relates to a testing system for portable electronic devices, and, more particularly, to a testing system including a plurality of testing apparatuses and inspecting the testing apparatuses instantly.

2. Description of Related Art

In production of portable electronic devices such as mobile telephones or laptops, assembled portable electronic devices require quality control testing. Generally, a typical testing system includes a testing apparatus and a processor. Testing program and testing parameters are input into the processor, and the processor is connected to the testing apparatus. The portable electronic devices are placed on the testing apparatus, and the testing apparatus receives testing data of each portable electronic device. The testing data is then transferred to the processor, and the processor processes the testing data and outputs testing results.

Actually, when producing the portable electronic devices in factories, the number of the portable electronic devices requiring testing is usually very large. Testing the portable electronic devices needs a plurality of the typical testing systems. However, the processor each testing system needs the testing program and the testing parameters, and the testing program and the testing parameters often need to be changed according to different kinds of quality demands. Therefore, inputting the testing program and testing parameters into each testing system need much work, thus costs much time and manpower.

Additionally, when a large number of typical testing systems are used, there are not any contacts between the testing systems. If a testing system makes some mistakes and outputs inaccurate testing results, the mistakes can be difficult to find in time. Thus testing results of many portable electronic devices tested by this testing system are likely to be inaccurate. A large number of portable electronic devices must then be retested, thus production is delayed.

Therefore, an improved testing system for portable electronic devices and an improved testing method are desired in order to overcome the above-described shortcomings.

### SUMMARY OF THE INVENTION

In one aspect, a testing system for testing quality of portable electronic devices includes a processor and a plurality of testing apparatuses connected to the processor. The processor includes a database module; the database module saves testing programs and testing parameters. The testing apparatuses are configured for receiving testing data from the portable electronic devices and sending the testing data to the processor. The processor processes the testing data to test quality of the portable electronic devices and check working status of each testing apparatus at the same time of testing quality of the portable electronic devices.

In another aspect, a testing method for testing quality of portable electronic devices includes the steps of: providing a testing system, the testing system including a processor and a plurality of testing apparatuses being connected to the processor; the processor including a database module, the database module saving testing programs and testing parameters; the testing apparatuses being configured for receiving testing data from the portable electronic devices and sending the testing data to the processor; the processor processing the testing data to test quality of the portable electronic devices and check working status of each testing apparatus at the same time of testing quality of the portable electronic devices; initializing the testing system; placing the portable electronic devices into the testing apparatuses and testing the portable electronic devices to receive testing data; and processing the testing data and checking working status of each testing apparatus via the processor.

Other advantages and novel features will become more apparent from the following detailed description when taken in conjunction with the accompanying drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts through out the several views.

FIG. 1 is a diagram of a testing system in accordance with a preferred embodiment of the present invention;

FIG. 2 is a diagram of a processor of the testing system shown in FIG. 1;

FIG. 3 is a diagram of a testing apparatus of the testing system shown in FIG. 1 connecting to the processor shown in FIG. 2; and

FIG. 4 is a flow chart of a testing method in accordance with a preferred embodiment of the present invention.

### DETAILED DESCRIPTION OF THE INVENTION

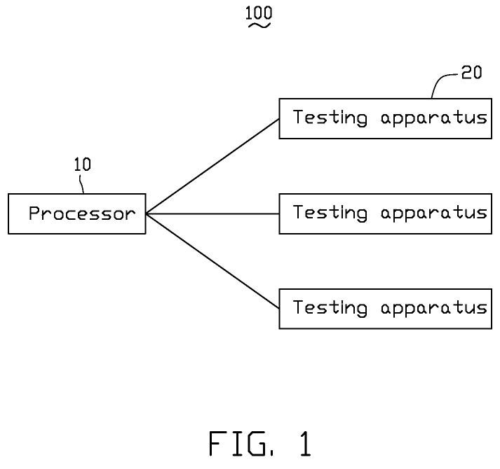

Referring now to the drawings in detail, FIG. 1 shows a testing system 100 in accordance with a preferred embodiment. The testing system 100 includes a processor 10 and a plurality of testing apparatuses 20. The processor 10 can be a computer or a single-chip, etc. All testing apparatuses 20 are connected to the processor 10.

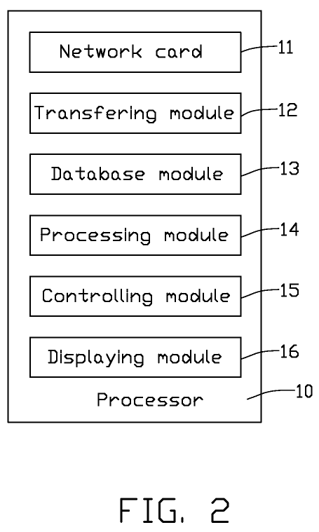

Also referring to FIG. 2, the processor 10 includes a network card 11, a transferring module 12, a database module 13, a processing module 14, a controlling module 15 and a displaying module 16. The testing apparatuses 20 are all connected to the network card 11, thus the processor 10 and the testing apparatuses 20 form a local area network (LAN). The transferring module 12 can transfer data and instructions between the processor 10 and the testing apparatuses 20. The database module 13 can save testing programs and testing parameters. The processing module 14 can process testing data received by the testing apparatuses 20 and inspect the testing apparatuses 20. The controlling module 15 can control the testing apparatuses 20 at a long distance. The displaying module 16 can display testing results and working status of the testing apparatuses.

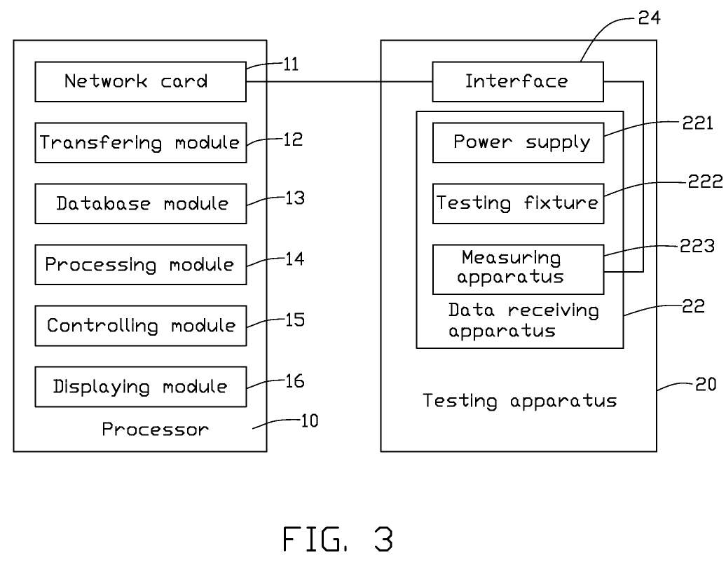

Also referring to FIG. 3, each testing apparatus 20 includes a data receiving apparatus 22 and an interface 24 connected to the data receiving apparatus 22. The data receiving apparatus 22 includes a testing power supply 221, a testing fixture 222 and a measuring apparatus 223. The measuring apparatus 223 can be a multimeter (i.e., a meter capable of measuring multiple variables). The testing power supply 221 is connected to the testing fixture 222. The testing fixture 222 is connected to the measuring apparatus 223. The measuring apparatus 223 is connected to the interface 24. The interface 24 of each testing apparatus 20 is connected to the network card 11 of the processor 10, data and instructions can be transferred via the interface 24.

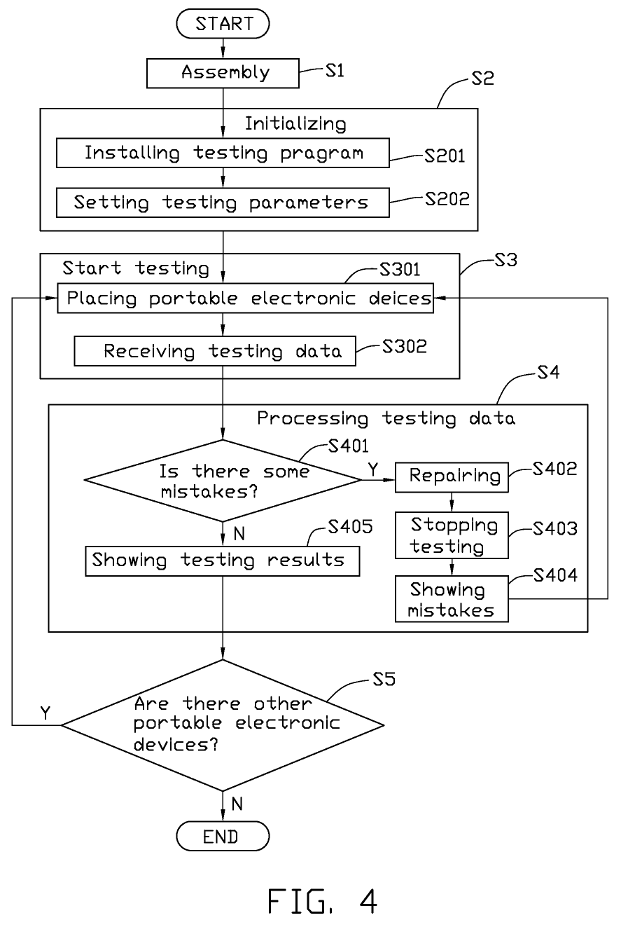

Referring to FIG. 4, a testing method for testing quality of portable electronic devices in accordance with a preferred embodiment of the present invention is provided. The testing method uses at least a testing system 100 to test a plurality of portable electronic devices and includes steps as follows.

Assembling the testing system 100 (Step S1), the interface 24 of each testing apparatus 20 is connected to the network card 11 of the processor 10. After assembling, power supplies of the processor 10 and the testing apparatuses 20 are turned on.

Initializing the testing system 100 (Step S2). Firstly, testing program is input into the database module 13 (Step S201), and testing parameters are set in the database module 13 to determine acceptable ranges of various testing data (Step S202). Understandably, if the testing system 100 is not used at the first time, the testing program of the system is already saved in the database module 13; thus the step S201 can be omitted, only the testing parameters need to be set.

After initialization, the testing system 100 can be used to test portable electronic devices (Step S3) to receive testing data. A plurality of portable electronic devices requiring testing are placed into the testing fixtures 222 of the testing apparatuses 20 respectively (Step S301). The controlling module 15 controls the testing fixtures 222 and the measuring apparatuses 223. The testing fixtures 222 switch on many kinds of circuit of the portable electronic devices according to the testing program. The measuring apparatuses 223 receive relative testing data such as voltage, current and resistance of these circuits according to the testing program (Step S302).

The testing data received by all testing apparatuses 20 is transferred to the transferring module 12 via the interface 24 and the network card 11, and then the transferring module 12 transfers the testing data to the processing module 14 to process (Step S4). The processing module 14 compares the testing data of each portable electronic device with the testing parameters saved in the database module 13 to judge testing results. If the testing data of a portable electronic device does not exceed an acceptable range determined by the testing parameters, the portable electronic device passes the test. Contrarily, if the testing data of a portable electronic device exceeds the acceptable range, the portable electronic device cannot pass the test.

At the same time of testing the portable electronic devices, the processor 20 also checks working status of each testing apparatus 20 instantly. The processing module 14 compares the testing data received by each testing apparatus 20 with that received by other testing apparatuses 20 to check working status of each testing apparatus 20 (Step S401). If there is a large difference between the testing data of a number of portable electronic devices received by a testing apparatus 20 and that received by other testing apparatuses 20, and the difference exceeds an acceptable range determined by the testing parameters, the processor 10 judges that the testing apparatus 20 makes mistakes (Step S402). The controlling module 15 then controls this testing apparatus 20 to stop testing work (Step S403) to prevent more testing mistakes, and alerts operators that this testing apparatus needs to be repaired (Step S404). After the testing apparatus 20 is repaired, the controlling module 15 controls the testing apparatus 20 to switch to the Step S4 and test portable electronic devices again.

The testing result of each portable electronic device is shown by the displaying module 16 (Step S405). When each portable electronic device has been tested, the processor 10 checks whether there are other portable electronic devices requiring testing or not (Step S5). If there are other portable electronic devices requiring testing, the testing system 100 switches to the Step S302, a new portable electronic device is placed into the testing fixture 222, and the Steps S302 to S405 run again. If there are not other portable electronic devices requiring testing, the testing work is finished.

Understandably, the measuring apparatus 223 can also be an ergometer, a sensor, an image sensing module, or combination of some or all aforementioned apparatuses. In this way, besides testing electrical quality, the testing system 100 can also be used in testing mechanical quality and optical quality of the portable electronic devices. These apparatuses are all connected to the processor 10 via the interface 24, thus testing data received by these apparatuses can be transferred to the processor 10 to be processed. Additionally, the processing module 14 can process the testing data at the same time of receiving the testing data or after the testing data of all portable electronic devices requiring to be tested are received.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A testing system for testing quality of portable electronic devices, comprising:
a processor, the processor including a database module, the database module saving testing programs and testing parameters; and
a plurality of testing apparatuses being connected to the processor, the testing apparatuses being configured for receiving testing data from the portable electronic devices and sending the testing data to the processor; the processor processing the testing data to test quality of the portable electronic devices and check working status of each testing apparatus at the same time of testing quality of the portable electronic devices.

2. The testing system as claimed in claim 1, wherein the processor includes a processing module, the processing module processes the testing data.

3. The testing system as claimed in claim 2, wherein the processing module compares the testing data of each portable electronic device with the testing parameters saved in the database module to judge testing results.

4. The testing system as claimed in claim 2, wherein the processing module compares the testing data received by each testing apparatus with that received by other testing apparatuses to check working status of each testing apparatus.

5. The testing system as claimed in claim 1, wherein the processor includes a transferring module, the transferring module transfers data and instructions between the processor and the testing apparatuses.

6. The testing system as claimed in claim 1, wherein the processor includes a controlling module, the controlling module controls the testing apparatuses.

7. The testing system as claimed in claim 1, wherein the processor includes a displaying module, wherein the displaying module displays testing results and working status of the testing apparatuses.

8. The testing system as claimed in claim 1, wherein the processor includes a network card, each testing apparatus is connected to the network card.

9. The testing system as claimed in claim 8, wherein the testing apparatus includes a data receiving apparatus and an interface, the data receiving apparatus is connected to the interface.

10. The testing system as claimed in claim 9, wherein the data receiving apparatus includes a testing power supply, a testing fixture and a measuring apparatus; the testing power supply is connected to the testing fixture, and the testing fixture is connected to the measuring apparatus.

11. The testing system as claimed in claim 10, wherein the measuring apparatus is connected to the interface, and the interface is connected to the network card.

12. The testing system as claimed in claim 11, wherein the measuring apparatus is chosen in a group including a multimeter, an ergometer, a sensor, an image sensing module, and combination of some or all aforementioned apparatuses.

13. A testing method for testing quality of portable electronic devices, comprising the steps of:
providing a testing system, the testing system including a processor and a plurality of testing apparatuses being connected to the processor; the processor including a database module, the database module saving testing programs and testing parameters; the testing apparatuses being configured for receiving testing data from the portable electronic devices and sending the testing data to the processor; the processor processing the testing data to test quality of the portable electronic devices and check working status of each testing apparatus at the same time of testing quality of the portable electronic devices;
initializing the testing system;
placing the portable electronic devices into the testing apparatuses and testing the portable electronic devices to receive testing data; and
processing the testing data and checking working status of each testing apparatus via the processor.

14. The testing method as claimed in claim 13, wherein the processor includes a processing module, the processing module processes the testing data.

15. The testing method as claimed in claim 14, wherein in the processing step, the processing module compares the testing data of each portable electronic device with the testing parameters saved in the database module to judge testing results.

16. The testing method as claimed in claim 14, wherein in the checking step, the processing module compares the testing data received by each testing apparatus with that received by other testing apparatuses to check working status of each testing apparatus.

17. The testing method as claimed in claim 13, wherein the processor includes a network card, each testing apparatus is connected to the network card.

18. The testing method as claimed in claim 17, wherein the testing apparatus includes a data receiving apparatus and an interface that is connected to the network card, the data receiving apparatus is connected to the interface.

19. The testing method as claimed in claim 18, wherein the data receiving apparatus includes a testing power supply, a testing fixture and a measuring apparatus; the testing power supply is connected to the testing fixture, and the testing fixture is connected to the measuring apparatus.

20. The testing method as claimed in claim 19, wherein the measuring apparatus is chosen from a group including a multimeter, an ergometer, a sensor, an image sensing module, and combination of some or all aforementioned apparatuses.
